(19) United States
(12) Patent Application Publication
(10) Pub. No.: US 2026/0030392 A1
(43) Pub. Date: Jan. 29, 2026

(54) DEVICE COVER LOCKING

(71) Applicant: Lenovo Global Technology (United States) Inc., Morrisville, NC (US)

(72) Inventors: Mark Christopher Heidenfeldt, Apex, NC (US); Matthew Kohut, Cary, NC (US); Tarah Cook, Raleigh, NC (US); Gregory McNeil, Raleigh, NC (US)

(21) Appl. No.: 18/785,674

(22) Filed: Jul. 26, 2024

(51) Int. Cl. G06F 21/88

(52) U.S. Cl. CPC G06F 21/88

(57) ABSTRACT

One embodiment provides a method, the method including: receiving, from a device lock system, an indication to activate a physical locking mechanism located on a computing device; and initiating activation of the physical locking mechanism located on the computing device, wherein the physical locking mechanism, when activated, prevents a cover of the computing device from being opened. Other aspects are claimed and described.

### BACKGROUND

Many users have information handling devices (e.g., smartphones, tablets, laptop computers, personal computers, smart appliances, smart watches, etc.). Since users utilize the information handling device for a large variety of purposes, many of these devices are portable, thereby allowing a user to move the device from one location to another and still maintain the functionality of the device. The convenience of the portable information handling device has also carried over into the corporate world, where employers supply employees with portable information handling devices instead of stationary devices. This allows the employees to utilize the device anywhere that the employee may be performing functions on behalf of the employer.

However, one downside to portable information handling devices is that the smaller size does not provide as much ability to upgrade the device, for example, by upgrading processing capabilities, memory resources, hard drive or other data storage capacity, and/or the like. The larger more stationary devices, like personal computers, generally are more easily upgraded. Accordingly, due to the desire to utilize the portable devices, employers, companies, and other entities, generally replace the devices at a predetermined frequency or periodical timeframe. The replacement devices include the upgrades in resources that are desired by the employers, companies, or other entities. However, due to the fact that technology improves at such a rapid rate, the replacement timeframe may be small, for example, every year, every 18 months, and/or the like. For an entity have a large number of portable devices, this can become quite expensive. Additionally, some entities may have needs or requirements for devices having resources superior to the current devices, but may not require such resources constantly, meaning the current devices would be acceptable most of the time, but are not usable for performing particular tasks or jobs.

### BRIEF SUMMARY

In summary, one aspect provides a method, the method including: receiving, from a device lock system, an indication to activate a physical locking mechanism located on a computing device; and initiating activation of the physical locking mechanism located on the computing device, wherein the physical locking mechanism, when activated, prevents a cover of the computing device from being opened.

Another aspect provides a system, the system including: a physical locking mechanism located on a device; a processor; a memory device that stores instructions that, when executed by the processor, causes the system to: receive, from a device lock system, an indication to activate a physical locking mechanism located on a computing device; and initiate activation of the physical locking mechanism, wherein the physical locking mechanism, when activated, prevents a cover of the computing device from being opened.

A further aspect provides a product, the product including: a computer-readable storage device that stores executable code that, when executed by a processor, causes the product to: receive, from a device lock system, an indication to activate a physical locking mechanism located on a computing device; and initiate activation of the physical locking mechanism located on the computing device, wherein the physical locking mechanism, when activated, prevents a cover of the computing device from being opened.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for locking a cover of a device to prevent the cover from being opened using a physical locking mechanism.

FIG. 4 illustrates an example device having a physical locking mechanism.

### DETAILED DESCRIPTION

One solution to the continued and frequent need to upgrade portable devices is for a company to lease a device. In such an arrangement, an entity takes responsibility for the device, including maintenance, installation of desired programs and applications, and/or the like, for a predetermined period of time. Once the lease period expires, the entity can choose to purchase the device from or return to the device to the lessor. This arrangement may work well for an entity that has departments that can support taking responsibility for the device. Additionally, this arrangement may work well when the desired device does not need to have any special capabilities, for example, the ability to perform particular tasks or have particular resources. However, an entity may be unable to lease a device that has superior resources, particularly if those resources are only needed for a short period of time less than a typical lease term.

Another solution that allows an entity to have more targeted capabilities is a device-as-a-service (DaaS) arrangement. In such an arrangement a third-party, (which is usually, but not always, a device manufacturer), provides devices to an entity and the third-party maintains responsibility for the device. As the entity needs different capabilities, the entity can contact the third-party and the third-party provides the desired capabilities. The third-party may be paid on a per-device basis, per resource utilization basis, and/or the like. Thus, in a device-as-a-service arrangement the third-party is responsible for providing not only the device to the entity, but is also responsible for supporting the utilization of the device and any resources the entity may need. Such an arrangement is particularly attractive to an entity that may have resource needs that vary across different time periods.

While lease and device-as-a-service arrangements are attractive to both the entity and the third-party or lessor, some problems may arise for either the entity or the third-party/lessor. One problem occurs if an individual should no longer have access to a device. This may happen if an employee becomes no longer employed with the entity, security levels of an employee change, the employee is in a location where the device should not be accessed, and/or the like, while the employee still has control over or possession of the device. Another time such a situation may occur is if the entity is no longer paying for use of a device or resource capabilities of a device, but has not yet returned the device to the third-party/lessor. Traditionally, there is not an effective way of preventing a user from accessing a device when they should not do so. An entity may tether a device to a stationary location through the use of device locks, but this only prevents the device from being moved from the location and does not prevent the device from being utilized. User profiles can be modified so that a user cannot access particular applications, but user profiles can be circumvented, it can take time to modify the profiles, and, in some cases, an entity may need access to the device in order to effectuate such a change.

Accordingly, the described system and method provides a technique for locking a cover of a device using a physical locking mechanism to thereby prevent the cover from being opened. A device is equipped with a physical locking mechanism that prevents a cover of the computing device from being opened. The cover of the device generally covers the display and/or input device of the device. Accordingly, if the cover of the device is locked and prevented from being opened, the device cannot be utilized by unauthorized individuals or by authorized individuals at unauthorized locations, times, or within other unauthorized contexts. Specifically, the individual is unable to open the device in order to provide inputs to the device, thereby rendering the device useless to the individual.

Upon receiving an indication from a device lock system to physically lock a device, the device lock system initiates activation of the physical locking mechanism, thereby prevent the cover of the device from being opened. The indication to lock the device may be received from the third-party/lessor or the entity. For example, if the entity is no longer paying for the device or resources of the device, the third-party can send instructions to lock the device. As another example, if the entity terminates the employment of an employee, the entity can send instructions to lock the device. Conversely, there may be situations where the locking mechanism is always activated to lock the device and the locking system may unlock the locking mechanism upon fulfillment of some conditions or rules. In this case, the indication to physically lock the device may be that the conditions or rules have not been met.

Therefore, a system provides a technical improvement over traditional methods for device security and device access prevention. Instead of conventional techniques that require access to a device to change permissions or user profiles, the described system and methods allows for an entity to prevent access to the device without having either physical or virtual access to the device. Additionally, unlike conventional techniques that prevent a device from being moved from a stationary location through the use of a physical lock, the described system and method can lock the device to prevent access instead of simply preventing a device from being moved from a particular location. Thus, particularly in view of device leases and device-as-a-service arrangements, the described system and method provides a technique that allows an entity to physically lock a device cover to prevent access to a device when access to the device should be prevented.

The illustrated example embodiments will be best understood by reference to the figures. The following description is intended only by way of example, and simply illustrates certain example embodiments.

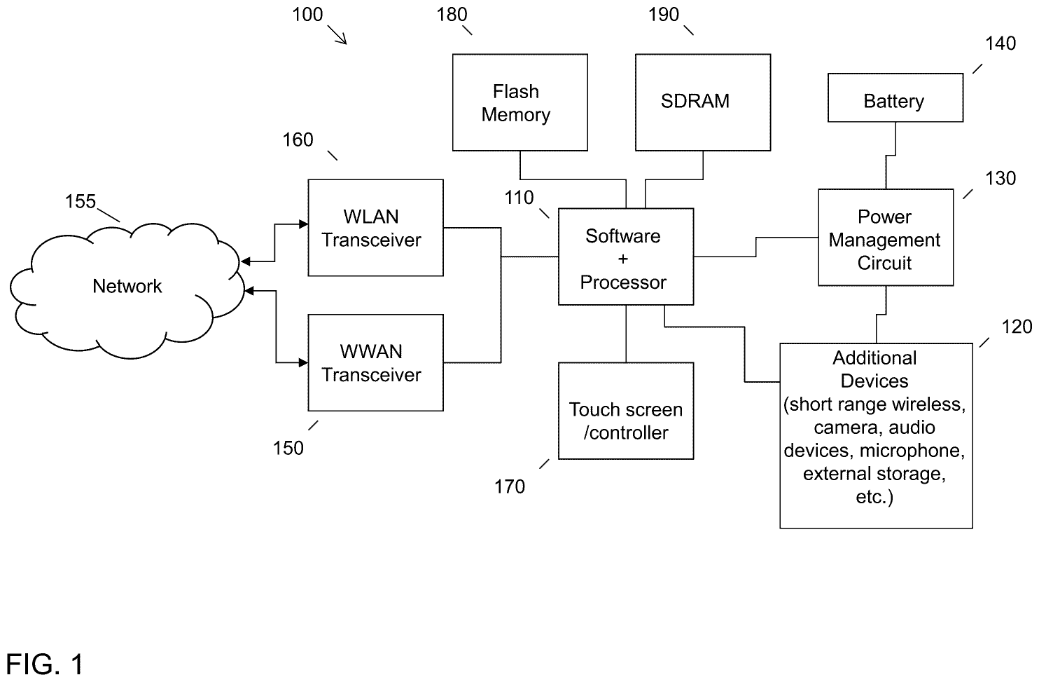

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

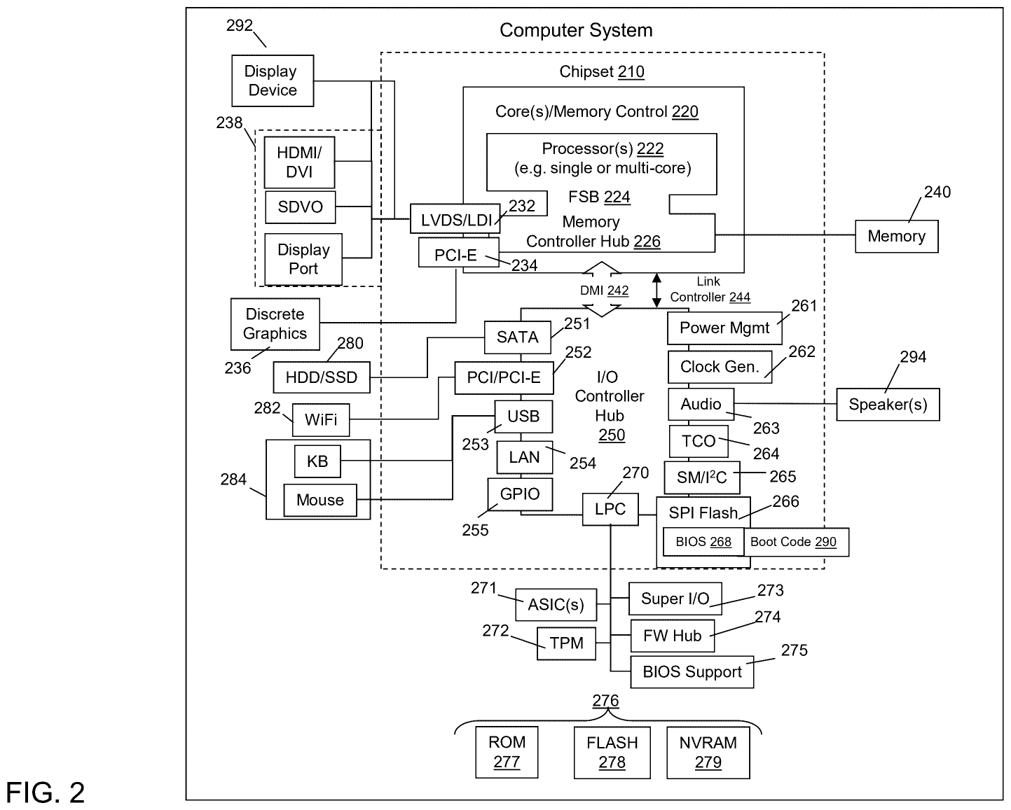

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used within devices that have physical locking mechanisms or within systems that communicate with such devices. For example, the circuitry outlined in FIG. 1 may be implemented in a tablet or smart phone embodiment, whereas the circuitry outlined in FIG. 2 may be implemented in a personal computer embodiment.

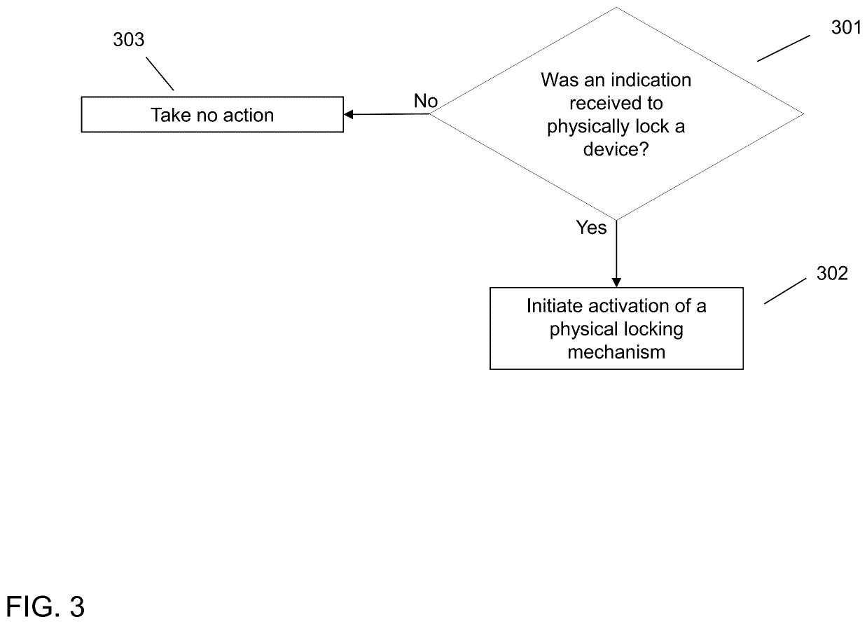

FIG. 3 illustrates an example method for locking a cover of a device to prevent the cover from being opened using a physical locking mechanism. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to lock a device with a physical locking mechanism. Additionally, the device lock system includes modules and features that are unique to the described system.

Many devices have integrated covers that can be opened and closed to access input and/or display portions of the device. For example, an A cover on a laptop is the top portion that generally houses the display. When the cover is in the closed position, the cover covers the keyboard and other input devices located on the bottom portion of the laptop. Not only does the cover help protect the display, input mechanisms (e.g., keyboard, trackpad, pointing stick, other mouse control devices, numeric keyboard, touch screen, etc.), and other sensitive portions of the device, but it also keeps any information displayed or visible on the device secure by concealing the information beneath the cover. Other devices have covers which can be rotated and otherwise manipulated to change the configuration of the device. Such devices are often referred to as convertible devices. The covers on these devices can, like the laptop configuration, be manipulated to cover the display and input portions of the device. In other words, regardless of the device type, the integrated cover generally allows the device to be put into a position where most, if not all, input and display portions are covered and not visible unless the cover is opened or otherwise manipulated.

While a laptop or other similar device having an integrated cover will be discussed herein and utilized as the primary example, it should be noted that the described system and method is not solely limited to such devices. For example, some devices without integrated covers, for example, a tablet, personal digital assistant, smart watch, etc., may have covers that can be installed on the device. For example, a user may purchase a tablet and then buy a case for the tablet that has a cover. In this example, the cover is integral to the case which is installed on the tablet, with the cover of the case functioning similar to an integrated cover of a device. Additionally, while most devices that may have a cover are portable devices, the described system and method can be utilized on any device with a cover regardless of the portability of the device. Thus, the described system and method can be utilized on any device having a cover that can be moved from one position to another regardless of whether the cover is integrated into the device or installed on the device by a user and regardless of whether the device is a portable device or not.

The device lock system can be utilized in a variety of situations in order to prevent one or more individuals or users from accessing a device. Specifically, the device lock system utilizes a physical locking mechanism to prevent the cover of the device from being opened. Thus, the system can be utilized in any situation where a user or other individual needs to be prevented from accessing the contents of the device. For example, the device lock system can be used to prevent a user or individual from accessing the device after some condition has been fulfilled (e.g., the user is no longer authorized to access the device, the user is within a location or environment when access to the device should be prevented, the user is in proximity to a user or location who should not have access to the device, other contextual situations, etc.). As another example, the device lock system can be activated at all times and only unlocked if some condition has been fulfilled (e.g., the user is authenticated and authorized to access the device, the device is in a secure location, other context-based situations, etc.). Thus, the device lock system may be used to prevent users or individuals from accessing the device after the user previously had access to the device or may be used to allow access to the device once a user and context has been authorized.

Accordingly, the device lock system may be activated in order to secure a device from unauthorized access. To activate the device lock system an entity, user, or system may send a signal or instructions to the device lock system to physically lock the device. Thus, the system may be automatically activated by an application that provides instructions to the system or may be manually activated by a user providing input to the system. The automatic activation of the device lock system may be based upon the detection of a trigger event indicating that the system should be activated. Example trigger events include detection of fulfillment of a condition to activate or deactivate the physical locking mechanism, a request received by an entity or individual that indicates the device needs to be locked, activation of software or an application utilizing the device lock system, and/or the like.

The device lock system may be made of multiple systems or modules that communicate together to make up the device lock system or may be a single system. The device lock system may be a standalone system, may be accessible through other computing devices, and/or a combination thereof. For example, the device lock system may be a standalone system that can be accessed by a user and/or may be or provide an application that is accessible by a user on another computing device. The device lock system may be accessible using any type of computing device, for example, personal computer, laptop computer, smartphone, tablet, smartwatch, head-mounted display, smart television or other smart appliance, augmented reality device, virtual reality device, and/or the like. Thus, the device lock system may be accessible locally using a computing device where the device lock system is installed and/or may be accessible remotely through another computing device. For example, the device lock system may be accessed by a user using a device that communicates with the device lock system to provide instructions for activating or deactivating locks on devices, verifying the lock status of a device, and/or the like. However, the device lock system may be located and operate on a different information handling device to perform the described steps.

The device lock system may have an associated graphical user interface. The graphical user interface may be provided on a display or monitor, which may or may not be associated with the device lock system. In other words, the device lock system may have a dedicated display or monitor or may be accessible using any display or monitor. In either case, the device lock system may provide instructions to generate and display the graphical user interface on the display device being used to access the device lock system. The graphical user interface may also be updated and managed based upon instructions provided by the device lock system. In other words, the device lock system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the device lock system. For example, the device lock system may utilize a user profile, client profile, historical information, schedule information or other context rule or lock condition information, device information, and/or the like, to identify contexts or situations when the device lock should be activated or deactivated and the devices for which the device lock system should be deployed. The graphical user interface may allow for creation of or access to these profiles, historical information, or context rule information by allowing a user to input information regarding the contexts and environments with corresponding activation/deactivation information, the device information, and/or the like. As will be discussed in more detail, the use of user provided information is not the only way that the profile and/or historical information can be created. The device lock system can then utilize these inputs to create the profile(s), store the historical information, create context rule information, and/or the like.

A user could also use the graphical user interface to adjust information within the profile(s), historical information, context rules or lock conditions, and/or the like. Additionally, or alternatively, the user can input a location of information related to one or more of the profiles, historical information, context rule information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, context rules or lock condition information, activation/deactivation information, device information, and/or the like. It should be noted that the information to be used by the device lock system and information provided by the device lock system can be different for different applications, different computing systems, different users, and/or the like. Thus, the information corresponding to input or output of the device lock system are not always the same. However, the device lock system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The device lock system may utilize one or more artificial intelligence models in automatically determining when a physical lock should be activated and/or deactivated. While the activation and deactivation of the locks may typically be responsive to receiving a trigger event or a manual user input, artificial intelligence models could be designed to provide the trigger events, analyze context information to determine if a trigger event has been received, or any other steps within the described system. Artificial intelligence models may also be used for steps within a step. For example, a model could be utilized to identify contexts that indicate a physical lock should be activated or deactivated, generate instructions to initiate activation or deactivation of the physical locking mechanism, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the device lock system or may be a model that is created from scratch. Since the device lock system is used in conjunction with activating and deactivating physical locking mechanisms for devices, some models that may be utilized by the system are analysis models, similarity identification models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The device lock system may include different components for carrying out different functions of the system, including different steps to be performed. These components may be hardware components or software components. Some software components include the user or device profile that provides information related to the user and device. The user information may include information related to a specific user that is assigned to the device or may include information related to the entity that is leasing or paying for the device. The device profile may include information specific to the device, for example, model, resource capabilities, serial number, identifiers, and/or the like. The device profile may also include information related to communication networks (e.g., IP address, network connections, etc.), location information, sensor information, and/or the like. The device profile may also include information that allows a third-party or other entity to communicate with the device or physical locking mechanism of the device in order to provide instructions regarding the activation or deactivation of the locking mechanism. The user and device profiles may provide information regarding contexts, rules, lock conditions, or other information identifying trigger events that indicate the locking mechanism should be activated or deactivated, thereby locking or unlocking the device.

Some hardware devices that may be utilized by the device lock system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the device lock system. For example, the device lock system may include speakers, displays or monitors, haptic output devices, audio output devices, and/or the like. Other hardware components may be included on the device having the physical locking mechanism and information from these components may be utilized by the device lock system to determine if a trigger event has been received that may indicate the physical locking mechanism should be activated or deactivated. For example, the device may include proximity sensors, image capture devices, audio capture devices, audio output devices, display devices, location detection components or sensors, biometric sensors, input devices, and/or the like.

The information captured from the device components, devices around the device, or other contextual information which may be captured by the device, other devices, provided by the user, and/or the like, can be utilized by the system to determine a context of the device and determine if a trigger event has been detected which may indicate that the locking mechanism should be activated or deactivated. The determination may be a simple comparison where the information is compared to one or more rules which indicate when a locking mechanism should be activated or deactivated. The determination may also be a more complex analysis where the information is analyzed to determine an overall context of the device and then the overall context is utilized to determine if the mechanism should be activated or deactivated. The more complex analysis may include traversal of a series of rules, use of one or more artificial intelligence models, and/or the like.

Additionally, the device lock system includes physical locking mechanisms that are installed on a device and corresponding cover in order to prevent the cover from being opened when the locking mechanism is activated. The physical locking mechanism may include two corresponding components. For example, the physical locking mechanism may include magnets where one magnet is placed on one portion of the device and the other corresponding magnet is located on the cover of the device in a location such that when the cover is closed, the corresponding magnets are aligned. While other magnets may be utilized, electro-permanent magnets may be particularly useful since the state of the magnet can be changed with the provision of an electrical signal. In other words, an electro-permanent magnet can be activated and deactivated with the provision of an electrical signal. In an activated state, the two portions of the electro-permanent magnet are attracted to each other, thereby creating a “bond” between the magnets. When installed on the device and the cover, this bond would prevent the cover from being opened. In a deactivated state, the magnetic field of the magnets is deactivated which means that the two portions of the magnet are not attracted to each other. When installed on the device and the cover, the deactivated magnets would not be attached, thereby allowing the cover to be opened. Other types of magnets can be utilized, for example, electromagnets.

Additionally, or alternatively, other types of physical locking components could be utilized. For example, latches and receivers could be installed within the device and cover. Upon receiving an activation signal, the latch could be manipulated to fit and position within the receiver so that the latch and receiver cannot be pulled apart, thereby preventing the cover from being opened. Essentially, any two-part signal-controlled physical locking mechanism can be utilized. One part would be installed on or within the device and the other complementary part would be installed on or within the cover. At least one of the parts could receive a signal that would activate one of the parts to connect with the other complementary part, thereby preventing the cover from opening. Similarly, a part, either the same part or the other complementary part, could receive a signal that would deactivate the part or other complementary part, thereby allowing the cover to be opened. In other words, the signal would indicate that a state of at least one of the parts of the locking mechanism should be changed to another state in order to lock or unlock the device.

The physical locking mechanism may require a power source to be activated or deactivated or to maintain activation or deactivation, depending on the type of locking mechanism. Accordingly, the physical locking mechanism may be connected to the power source of the device, thereby drawing power from the device power source, or may have a separate power source, for example, a battery. The locking mechanism may also be able to be powered from multiple power sources, for example, power from the device and a separate battery. In this case, one of the power sources may be the main source of power and the locking mechanism may draw from the other power source in the event that the main source of power is not available.

Additionally, the physical locking mechanism may include a fail-safe mode where, upon removal of the power source (e.g., the battery is below a level necessary for powering the locking mechanism, the battery dies, the power source is removed or disconnected, etc.), the physical locking mechanism will move to a safe state. Depending on the use case, the safe state may be the unlocked or deactivated state or the locked or activated state. For example, in a use case where the device is typically unlocked, the fail-safe mode may be a locked or activated state. As another example, in a use case where the device is typically unlocked, the fail-safe mode may be an unlocked or deactivated state.

At 301, the system determines if an indication to activate a physical locking mechanism located on a computing device has been received from a device lock system. The indication to lock the device may be responsive to a trigger event. The trigger event can be an automatic event or a manual event. The indication to the lock the device may either by provided by a remote computing device, for example, a computing device of a entity or company that has control or can access the device lock system, or may be provided by the computing device upon which the physical locking mechanism is installed. Thus, the computing device could recognize a trigger event and cause the physical locking mechanism to lock/unlock. A manual trigger event may be an entity having control over the device lock system accessing the device lock system and indicating that the device should be locked. Thus, the indication to physically lock the device may be received from a remote device with respect to the device. In other words, a user or entity may access a remote device that sends the signal to the physical locking mechanism of the device to lock or unlock the device.

The entity or user may access a graphical user interface, application associated with the device lock system, application associated with the device, and/or the like, and provide input indicating that a device should be locked. For example, a teacher may have an application associated with a learning environment. A tab within the learning environment application may be associated with student devices and may allow for a teacher to select a device, or group of devices, to be locked or unlocked. As another example, a third-party that supplies devices as part of a device-as-a-service arrangement may have an application that is associated with devices that are currently being held by entities. Within this application may be a section or tab where indications for locking/unlocking devices can be provided. As a final, but non-limiting example, the device lock system may have a unique graphical user interface or application, as previously discussed, and a user may provide input to this standalone graphical user interface or application for locking/unlocking devices.

Events that automatically cause the device lock system to lock/unlock a device are automatic trigger events. Automatic trigger events may include a device being within a particular context and the device lock system recognizes the context as a context where the device should be locked or unlocked. A context of the device may include one or more of, a time of day, a location of the device, a proximity of the device to other people, a type of network to which the device is connected, a user accessing the device, and/or any other type of characteristic of either the device, the user of the device, or the environment where the device is located. The context of the device can be determined using one or more sensors of the device, other devices, the user, and/or the like.

To determine if the current context of the device indicates that the device should be locked or unlocked, the system may compare the current context of the device to a set of context rules or lock conditions, where the context rules indicate contexts where the device should be locked or unlocked. Upon detection of a match between the context of the device and the context rules or lock conditions, the system automatically receives the indication to physically lock the device. Some context rules may include a locking schedule, where particular days, times of the day, and/or the like, indicate when the device should be locked. For example, student devices may have a schedule where devices are locked during particular classes or times of the day for particular days of the week. Thus, when the time or day or day of the week matches the locking schedule, the device will be locked. Another context rule may include identification of locations where the device should be locked. When the device is detected in the location, the system will automatically lock the device. The location may be identified by a specific coordinate, a configurable range of a specific coordinate or location, a name of a location, a general positioning of a location, within a geofence, a map position of a location, an address, or any other identifier that may identify a location, a range with respect to a location, and/or the like.

Another context rule may be an authorized users list. The authorized users list may include identification of users who are authorized to use the device. If a user who not an authorized user attempts to access the device, the system will automatically lock the device. Since the physical locking device may only work most effectively when the cover is closed, detection of an authorized user may be based upon detection of users within proximity to the device. For example, the system or device may receive signals from devices of users that are in proximity to the device. These signals can be used to identify the device and then identify the user who is associated with the device. The identified user can then be identified as an authorized user or not and, if not, the device cover may be locked.

Other context rules are contemplated and possible. For example, context rules may be based upon biometric information, dual-factor authentication, proximity to other devices, connection to certain types of networks (e.g., secure/unsecure networks, known/unknown networks, networks having certain capabilities, etc.), environmental conditions (e.g., weather, humidity measurements, temperature, etc.), outside influences (e.g., crime in proximity to the device, emergency alerts, etc.), and/or the like. Additionally, context rules may be more complicated than a single rule. Rather, context rules could be a combination of criteria or factors that result in the locking or unlocking of a device. For example, a combined context rule may indicate that a device in a particular location at a particular time should be locked. Additionally, different users of the same device or profiles of users of the same device could have different context rules which may result in the locking of the device under different contexts based upon the user or user profile.

The context rules may also be negative rules, where instead of indicating when the device should be locked, the rule indicates when the device should be unlocked. In this case, the default state of the physical locking mechanism may be locked and it will only be unlocked based upon the context rules. In the event that the default state is locked, the indication to lock the device will be received whenever the locking mechanism is active.

If an indication was not received to physically lock the device at 301, the system may take no action at 303. Taking no action means that the system will not change the state of the physical locking mechanism and it will remain in the previous state, whether that is a locked or unlocked state.

If, on the other hand, an indication to activate a physical locking mechanism located on a computing device was received at 301, the system, at 302, initiates activation of the physical locking mechanism located on the device. Activation of the physical locking mechanism prevents the cover of the device from being opened. In other words, when the physical locking mechanism is activated, the cover is held to the body of the device and cannot be opened due to the physical locking mechanism. As previously discussed, the activation of the physical locking mechanism may include the transmission of a signal from the device lock system, whether that is on a remote device or on the device itself, to the physical locking mechanism or a circuit of the physical locking mechanism that activates the physical locking mechanism by changing a state of the locking mechanism. In the case of a magnet, changing the state to activate the magnet causes activation of the magnetic field of the magnet, thereby causing the magnet to be attracted to the complementary magnet on the other portion of the device. In the case of a latch mechanism, changing the state may include movement of the latch to a position that holds the latch within a receiver. Thus, changing the state of the physical locking mechanism causes at least a portion of the locking mechanism to move or change so that the two parts of the locking mechanism are held together.

Upon activation of the physical locking mechanism, the system may receive confirmation that the locking mechanism has been activated. In other words, the device or the physical locking mechanism may send a signal back to the device lock system or entity that originally sent a signal to activate the physical locking mechanism, that the physical locking mechanism was successfully activated. Thus, if the physical locking mechanism were to fail to activate, the device lock system could be apprised of this failure. Additionally, if the physical locking mechanism was activated while the cover was opened, the physical locking mechanism may fail to activate to a point where the device is closed. This information could also be provided back to the device lock system. In this case, the device lock system may periodically send signals to the locking mechanism to activate until the locking mechanism is successfully activated. Alternatively, or additionally, a user may be apprised of the failure and then provide instructions to the device lock system regarding next steps.

Once the physical locking mechanism has been locked, a user or entity may want to unlock the device. Unlocking the device occurs in generally the same steps as locking the device. The device lock system can receive an indication to physically unlock the device, using any of the previously discussed techniques, and then initiate deactivation of the physical locking mechanism. Deactivation of the physical locking mechanism occurs similar to the activation of the physical locking mechanism with a signal the changes the state of the locking mechanism. However, instead of changing the state of the locking mechanism to a lock state, the state of the locking mechanism is changed to an unlock state, thereby allowing the cover to be opened. In the case that the locking mechanism was not successfully locked, the system may send an unlock signal, even if the cover was not closed, to change the state of the locking mechanism to the unlock state and then again attempt to lock the physical locking mechanism.

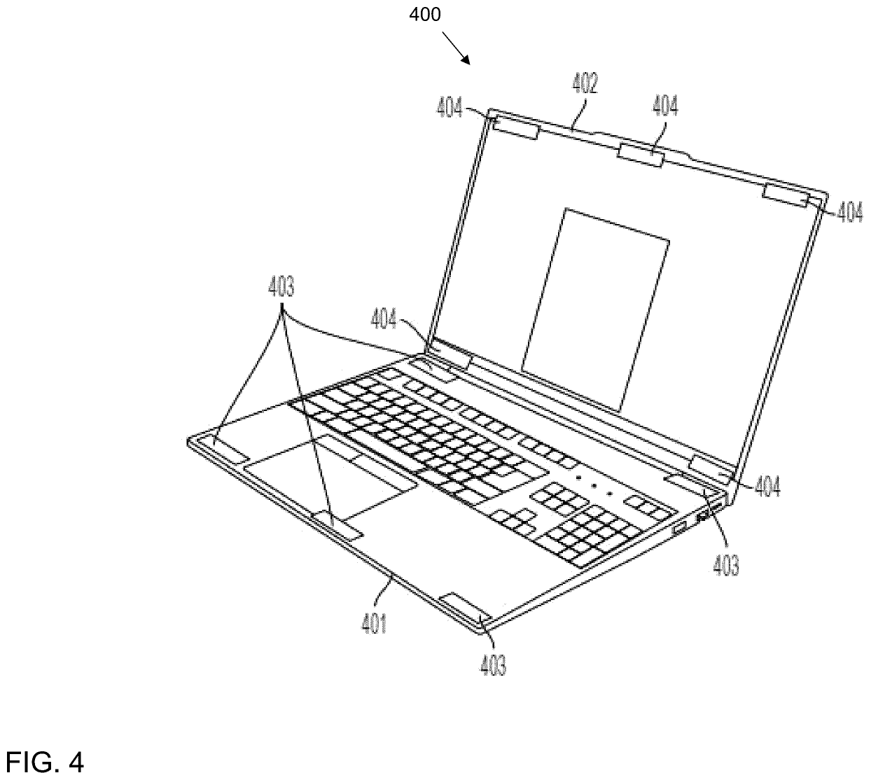

FIG. 4 illustrates an example of a device 400 with a physical locking mechanism. While a laptop is illustrated in FIG. 4, it should be noted that this is a non-limiting example, as any device having a cover, either integral to the device or later installed, can utilize the described system. Additionally, while the locking mechanisms 403 and 404 appear to be located on an outer face of the cover 402 and bottom portion 401, this is only for illustrative purposes. Rather, the locking mechanisms 403 and 404 may be located within the device and, therefore, not visible when the device 400 is open. Alternatively, the locking mechanisms could be visible when the device 400 is open.

The device 400 includes a bottom portion 401 and a cover 402. Within the bottom portion 401, is a first part of the physical locking mechanism 403. Within the cover 402 are the second part of the physical locking mechanism 404. As illustrated in

FIG. 4, each of the locking mechanisms 404 on the cover 402 is located in a corresponding or complementary position as compared to the part of the locking mechanism 403 on the bottom portion 401. Thus, when the cover is closed, the complementary parts of the locking mechanism work together to hold the cover 402 to the bottom portion 401 when the physical locking mechanisms 403 and 404 are activated. In other words, a first part of the physical locking mechanism is located on a first portion of the device and a second part of the physical locking mechanism is located on a second complementary portion of the device.

As illustrated in FIG. 4, there may be multiple physical locking mechanisms 403 and 404 located around the device 400. This may allow for a stronger connection between the locking mechanisms and assist in preventing the cover 402 from being opened even under a great force. Additionally, by utilizing multiple physical locking mechanisms 403 and 404, there may be less interference between signals or fields put off by the locking mechanism and any other components of the device. However, a single physical locking mechanism may be utilized and the locking mechanisms can be placed in different locations as compared to that illustrated in FIG. 4. In the case of multiple physical locking mechanisms, they may be operated as a group, thereby only requiring a single signal to activate or deactivate all locking mechanisms at the same time. Alternatively, signals may be sent to each locking mechanism or different groups of locking mechanisms.

As an overall non-limiting example of the described system, a user is assigned a device from an entity. The device is part of a device-as-a-service agreement with a third-party. The employment of the user is terminated, but the user still has the device. Alternatively, the employment of the user is not terminated, but the user loses the device. Therefore, the entity, either directly or by providing a request to the third-party, provides an indication that the device should be physically locked so that the user can no longer open the device or a person who has taken the device cannot open the device and access the information contained on the device. The entity, or third-party, accesses the device lock system and provides an indication that the device should be physically locked. The device lock system initiates the physical locking mechanism located on the device, for example, by sending instructions or a signal to the physical locking mechanism. The instructions or signal causes the physical locking mechanism to activate, thereby preventing the cover of the device from being opened.

As another overall non-limiting example, students in school have assigned devices that are brought to school every day. The teacher or other instructor has access to a device lock system which controls the physical locking mechanisms on the student devices. When the students enter the classroom, or at another time, the teacher can provide an indication to the device lock system that the student devices should be locked. The device lock system can include a grouping of devices that allows the teacher to provide a single indication that results in all of the physical locking mechanisms of all the student devices being activated at the same time. The teacher can thereafter provide an indication to deactivate the physical locking mechanism of the student devices once they are allowed to access the devices. The teacher may also only select a few of the devices to be locked/unlocked at a time.

As another overall non-limiting example, a device having a physical locking mechanism is indicated as having highly sensitive information. Thus, the indication to physically lock the device corresponds to any time the device should not be unlocked. In other words, the device is, by default, locked, instead of in the other examples when the default is that the device is unlocked. When a user attempts to access the device, the user is authenticated. Upon determining that the user is authorized to access the device, the device lock system sends a signal or instructions to unlock the device. In this example, other criteria may have to be met before the device will be unlocked. For example, the user may have to be in a particular location, may have to be a certain distance from other people, and/or the like, in order for the device to be unlocked by the system. However, this is not strictly necessary. Rather, the unlocking trigger event may be any set of criteria which may simply be authentication of the user or may include other criteria as determined by the entity controlling the device.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, from a device lock system, an indication to activate a physical locking mechanism located on a computing device; and
initiating activation of the physical locking mechanism located on the computing device, wherein the physical locking mechanism, when activated, prevents a cover of the computing device from being opened.

2. The method of claim 1, comprising transmitting a confirmation of the activation of the physical locking mechanism to the device lock system.

3. The method of claim 1, wherein the receiving an indication comprises receiving a signal from a remote device to lock the device.

4. The method of claim 1, wherein the receiving an indication comprises identifying a match between a lock condition and a context of the device.

5. The method of claim 4, wherein the lock condition comprises a location and wherein the context of the device comprises the device being located at the location.

6. The method of claim 4, wherein the lock condition comprises a lock schedule and wherein the context of the device comprises a time identified within the lock schedule as a time for the device to be locked.

7. The method of claim 1, wherein the physical locking mechanism comprises an electromagnet and wherein the initiating comprises transmitting a signal to change a state of the electromagnet.

8. The method of claim 1, comprising receiving an indication to physically unlock the device and initiating deactivation of the physical locking mechanism.

9. The method of claim 1, wherein the physical locking mechanism comprises a first part located on a first portion of the device and a second part located on a second complementary portion of the device.

10. The method of claim 1, wherein the initiating comprises receiving an input from a graphical user interface associated with the device lock system.

11. A system, the system comprising:
a physical locking mechanism located on a device;
a processor;
a memory device that stores instructions that, when executed by the processor, causes the system to:
receive, from a device lock system, an indication to activate a physical locking mechanism located on a computing device; and
initiate activation of the physical locking mechanism, wherein the physical locking mechanism, when activated, prevents a cover of the computing device from being opened.

12. The system of claim 11, comprising transmitting a confirmation of the activation of the physical locking mechanism to the device lock system.

13. The system of claim 11, wherein the receiving an indication comprises receiving a signal from a remote device to lock the device.

14. The system of claim 11, wherein the receiving an indication comprises identifying a match between a lock condition and a context of the device.

15. The system of claim 14, wherein the lock condition comprises a location and wherein the context of the device comprises the device being located at the location.

16. The system of claim 14, wherein the lock condition comprises a lock schedule and wherein the context of the device comprises a time identified within the lock schedule as a time for the device to be locked.

17. The system of claim 11, wherein the physical locking mechanism comprises an electromagnet and wherein the initiating comprises transmitting a signal to change a state of the electromagnet.

18. The system of claim 11, comprising receiving an indication to physically unlock the device and initiating deactivation of the physical locking mechanism.

19. The system of claim 11, wherein the physical locking mechanism comprises a first part located on a first portion of the device and a second part located on a second complementary portion of the device.

20. A product, the product comprising:
a computer-readable storage device that stores executable code that, when executed by a processor, causes the product to:
receive, from a device lock system, an indication to activate a physical locking mechanism located on a computing device; and
initiate activation of the physical locking mechanism located on the computing device, wherein the physical locking mechanism, when activated, prevents a cover of the computing device from being opened.
